(19) United States
(12) Patent Application Publication
(10) Pub. No.: US 2023/0140660 A1
(43) Pub. Date: May 4, 2023

(54) METHOD, SYSTEM AND DEVICE FOR SIMPLIFYING ELECTRONIC SIGNATURE PROCESS ON BASIS OF PDF DOCUMENT

(71) Applicant: Fujian Foxit Software Development Joint Stock Co., Ltd., Fuzhou City (CN)

(72) Inventors: Kewang YU, Fuzhou City (CN); Yuqian XIONG, Fuzhou City (CN)

(21) Appl. No.: 17/915,205

(22) PCT Filed: Mar. 19, 2021
(86) PCT No.: PCT/CN2021/000046

§ 371 Date: Sep. 28, 2022

(30) Foreign Application Priority Data
Apr. 17, 2020 (CN) 202010308048.4

(51) Int. Cl. G06F 21/64; G06F 21/60; H04L 9/32

(52) U.S. Cl. CPC G06F 21/64; G06F 21/602; H04L 9/3247; H04L 9/3263

(57) ABSTRACT

A system for simplifying an electronic signature process on the basis of a PDF document includes a form extension module for creating a standard PDF form field, and extending the standard PDF form field; a client module, used by an initiator to edit a PDF document, and used for writing initiator information in the PDF document, creating a PDF signature field and a PDF form field, designating a signer and writing signer information in the PDF document, designating a signature order and writing signature order information in the PDF document, determining the signature field and the signature order, generating a corresponding document summary and a document summary encrypted on the basis of a digital certificate, generating a final signed document, and verifying the validity of the signature; and a server module, used by the signer and initiator to log in, and for acquiring a signature style, signing a digital certificate, and verifying the validity of the signature.

### TECHNICAL FIELD

The present disclosure relates to the field of document processing and electronic signature, and more particularly, to a method and a system for simplifying an electronic signature process based on PDF document encryption or processing.

### BACKGROUND

Electronic signature refers to data contained in a data message in an electronic form and attached for identifying a signer's identity and indicating that the signer approves the content therein. Generally speaking, an electronic signature is a signature of an electronic document in an electronic form through a cryptographic technology, not just a digital image of a written signature. It is an important means of guaranteeing the data security of electronic documents, e.g., electronic signatures on confidential documents or important contract documents. An electronic signature system generally adopts a PDF document format to implement an electronic signature function.

The electronic signature has two basic functions: identifying a signer, and indicating the signer's approval of the content. In addition to the two basic functions of the electronic signature, the general electronic signature system also implements functions related to the signature process, the functions including:

(1) designating a signature document;

(2) designating signers and an order of signer's signatures;

(3) designating a signature position;

(4) designating a signature type, such as an abbreviated signature or a full signature; and

(5) designating which fields need to be filled in before signing.

In the prior art, however, in order to implement the above basic functions and functions related to the signature process, a traditional electronic signature system generally defines an additional set of data structures to describe data related to these functions. This set of data structures is generally referred to as an envelope in the electronic signature system. An envelope needs be created first each time a user initiates a signature process in the electronic signature system.

Based on the above-mentioned prior art, the process of implementing the electronic signature is generally as follows:

1. the initiator uses a PDF editor to read and edit a PDF document;

2. the initiator registers an account in the electronic signature system;

3. the initiator logs in to the electronic signature system;

4. the initiator uploads the PDF document to the electronic signature system;

5. the initiator creates an envelope in the electronic signature system, and specifies signature related information in the envelope, the information including: signers, a signature order, signature positions, signature types, fields that need to be filled in before signing, etc. If the initiator itself is the only signer, there is no need to designate signature information of other signers;

6. the signer will receive an email notification, where a person who receives the email represents a signer's identity; the signer clicks a link in the email, jumps to the electronic signature system, and signs the signature; and

7. the initiator and signer will receive an email notification indicating signing the signature sent by the electronic signature system, and download a final document.

This manner is complicated and requires additional creation of envelopes, which consumes a lot of system resources. Therefore, seeking a safe, concise and efficient electronic signature method has become an urgent problem to be solved in the market.

### SUMMARY

In view of the defects in the prior art, the present disclosure proposes a method and system for simplifying an electronic signature process based on a PDF document, which simplifies system resource consumption under the premise of ensuring the security of electronic signatures and document data. Specifically, the present disclosure provides the following technical solutions.

Firstly, the present disclosure provides a method for simplifying an electronic signature process based on a PDF document. The method includes:

step 1: creating a standard PDF form field, and extending the standard PDF form field;

proceeding to step 4 when a signer is an initiator, and proceeding to step 2 when the signer is not an initiator;

step 2: logging in to a server by the initiator; and then editing a PDF document in a client, writing initiator information in the PDF document, creating a PDF signature field and a form field, designating a signer, and writing signer information into the PDF document; designating a signature order, and writing signature order information in the PDF document; transmitting the signature order information to the server, and saving the PDF document in the client;

step 3: logging in to the server by the signer, and acquiring a signature style from the server, and determining, by the client, a signature field and a signature order to be processed according to a login identity of the signer; signing, by the signer, a signature, and generating a corresponding document summary; submitting, by the client, the document summary to the server for digital certificate encryption; generating, by the client, a final signed document based on the document summary with the encrypted digital certificate, and verifying validity of the signature; and

step 4: logging in to the server by the initiator, and then acquiring a signature style; editing the PDF document in the client, and writing the initiator information in the PDF document; signing the signature in the PDF document, and writing signer information into the PDF document; generating a document summary corresponding to the signature; submitting, by the client, the document summary to the server for digital certificate encryption; and generating, by the client, a final signed document based on the document summary with the encrypted digital certificate.

Preferably, in the step 1, extending the standard PDF form field includes:

adding a FoxitSign dictionary entry in the standard PDF form field, the FoxitSign dictionary entry using a FoxitSign key as a primary key and having a value containing initiator and/or signer related information; and

adding a Signer dictionary entry in the standard PDF form field, the Signer dictionary entry using a Signer key as a primary key and having a value being one piece of signer related information; and the Signer dictionary entry being configured in an interactive form field dictionary.

Preferably, the FoxitSign dictionary entry includes: a character string type entry Endpoint having a value being a service address of a signature service provider; a dictionary type entry Initiator having a value being initiator related information; an array type entry Signers having a value being information related to each signer, where the type of each array element is an indirect object; and a boolean type entry Sort having a value indicating whether there is a signature order.

Preferably, the dictionary type entry Initiator includes: a character string type entry Name having a value being a name of the initiator; and a character string type entry Email having a value being an email address of the initiator.

Preferably, an entry Signer contained in the array type entry Signers includes: a name type entry Type having a value of Signer; a character string entry Name having a value being a name of the signer; and a character string type entry Email having a value being an email address of the signer.

Preferably, in the step 3, the client determines the signature field and the signature order to be processed according to a login identity of the signer by means of the following manners:

step 31: acquiring an email of the current signer;

step 32: traversing all the signer information recorded in the document according to the extended standard PDF form field;

step 33: determining whether the signature order is designated, if YES, proceeding to step 34, and if NO, proceeding to step 35;

step 34: determining whether a signer having an order priority higher than that of the current signer has signed the signature, if YES, proceeding to step 35, and if NO, exiting; and

step 35: determining whether the signature field is a field to be processed by the current signer, if YES, processing and signing the signature, and if NO, hiding the signature field, or not allowing to operate the signature field.

Preferably, the server is also used to record a log in the signature process.

In another aspect, the present disclosure further provides a method for simplifying an electronic signature process based on a PDF document. The system includes:

a form extension module configured to create a standard PDF form field, and extend the standard PDF form field;

a client module used by an initiator configured to edit a PDF document in a client, write initiator information in the PDF document, create a PDF signature field and a PDF form field, designate a signer and write signer information in the PDF document, designate a signature order and write signature order information in the PDF document; and configured to:

determine the signature field and the signature order, that needs to be processed by the signer, for the signer to sign and fill in a form, generate a corresponding document summary, generate a final signed document based on the document summary encrypted with a digital certificate, and verify validity of the signature; and

a server module used by the signer and initiator to log in configured to acquire a signature style; encrypt the digital certificate for the document summary submitted by the signer; and verify the validity of the signature, wherein

the form extension module is arranged in the client module or independently arranged outside the client module.

Preferably, the form extension module configured to extend the standard PDF form field includes:

adding a FoxitSign dictionary entry in the standard PDF form field, the FoxitSign dictionary entry using a FoxitSign key as a primary key and having a value containing initiator and/or signer related information; and

adding a Signer dictionary entry in the standard PDF form field, the Signer dictionary entry using a Signer key as a primary key and having a value being one piece of signer related information; and the Signer dictionary entry being configured in an interactive form field dictionary.

In yet another aspect, the present disclosure further provides a device for simplifying an electronic signature process based on a PDF document. The device at least includes a processor and a memory, wherein the memory stores an executable instruction therein; and the processor can read the executable instruction in the memory to perform the above-mentioned method for simplifying the electronic signature process based on the PDF document.

Compared with the prior art, the technical solution of the present disclosure enables the PDF document to be electronically signed to be directly transferred between users, and users can complete all signature related actions in a PDF editor, thereby eliminating the trouble of additionally uploading the document to an electronic signature system and creating an envelope. The PDF-based signature process can be close to the written signature experience to the greatest extent, and is more concise and efficient.

### BRIEF DESCRIPTION OF THE DRAWINGS

FIG. 1 is a flowchart of an initiator initiating a signature according to an embodiment of the present disclosure;

FIG. 2 is a flowchart of a signer signing a document according to an embodiment of the present disclosure;

FIG. 3 is a flowchart of a signature from a unique signer according to an embodiment of the present disclosure; and

FIG. 4 is a flowchart of a client determining a signature order according to an embodiment of the present disclosure.

### DETAILED DESCRIPTION

The technical solutions in the embodiments of the present disclosure will be clearly and completely described below with reference to the drawings in the embodiments of the present disclosure. Obviously, the described embodiments are only a part of the embodiments of the present disclosure, not all of the embodiments. Based on the embodiments of the present disclosure, all other embodiments obtained by those of ordinary skill in the art without creative efforts shall fall within the protection scope of the present disclosure.

### Embodiment 1

In the prior art, in addition to implementing two basic functions of identifying a signer of an electronic signature and indicating the signer's approval of the content, an electronic signature system generally needs to implement: designating a signature document; designating signers and an order of signer's signatures; designating a signature position; designating a signature type, such as an abbreviated signature or a full signature; designating which fields need to be filled in before signing, etc. However, the existing way is to describe the above functional data by defining an additional set of data structures, thereby forming an envelope. If the above data are defined completely based on the PDF document itself, the electronic signature function can be simplified without creating an additional envelope in the electronic signature system:

(1) the document to be signed is a PDF document being read and edited in an PDF editor; and

(2) by extending a PDF form, signers, a signature order, signature positions, signature types, and fields that need to be filled in before signing, etc., can be directly designated in the PDF document.

In a specific embodiment, the PDF-based signature process proposed by the present disclosure is as follows:

(1) the initiator registers an account in the electronic signature system;

(2) the initiator logs in the electronic signature system in the PDF editor, and can directly read and edit the PDF document in the PDF editor, and also directly use a PDF form tool to designate the signers, signature order, signature positions, signature types, and fields that need to be filled in before signing, etc., in the PDF document. If the initiator itself is the only signer, a signature tool in the PDF editor can be directly used to complete the signature (equivalent to a pen used for a written signature) without the need to designate signature information of other signers, such that the following forwarding process is not required;

(3) the initiator sends a PDF document to the signer through any communication tool; and

(4) the signer logs in the PDF editor to verify a signer's identity, and signs the PDF document with the signature tool in the PDF editor (equivalent to a pen used for a written signature).

The differences between the simplified process of the present disclosure and the traditional written signature process as well as the signature process of the traditional electronic signature system are compared.

The traditional written signature process is as follows:

(1) a initiator uses a PDF editor to read and edit a PDF document;

(2) the initiator prints the PDF document;

(3) the initiator sends the written document for signature; and

(4) the signer picks up a pen and signs the written document.

The signature process of the traditional electronic signature system is as follows:

(1) an initiator uses a PDF editor to read and edit a PDF document;

(2) the initiator registers an account in the electronic signature system;

(3) the initiator logs in to the electronic signature system;

(4) the initiator uploads the PDF document to the electronic signature system;

(5) the initiator creates an envelope in the electronic signature system, and designates signature related information in the envelope, the information including: signers, a signature order, signature positions, signature types, and fields that need to be filled in before signing, etc. If the initiator itself is the only signer, there is no need to designate signature information of other signers;

(6) the signer will receive an email notification, where a person who receives the email represents a signer's identity; the signer clicks a link in the email, jumps to the electronic signature system, and completes the signature; and

(7) the initiator and the signer will receive an email notification indicating the completion of the signature sent by the electronic signature system, and download a final document.

It is found upon comparison that in the PDF-based signature process, the PDF document can be directly transferred between users, and users can complete all signature related actions in tge PDF editor, thereby eliminating the trouble of additionally uploading the document to the electronic signature system and creating an envelope. The PDF-based signature process can be close to the written signature experience to the greatest extent (equivalent to picking up a pen and signing a written document), and is more concise and efficient.

An electronic signature system based on a PDF document is composed of a client and a server. With respect to the server, industry-standard technologies are adopted for various traditional electronic signature systems. Therefore, technical details of the server will not be repeated in this case. Only the interaction process between the client and the server is described here, in order to illustrate the integrity of the entire technical solution. The main functions of the server include:

(1) user registration;

(2) user login;

(3) creating a signature style;

(4) encrypting a digital certificate of a document summary; and

(5) log record.

In a specific embodiment, the entire technical solution of the present disclosure mainly includes three processes:

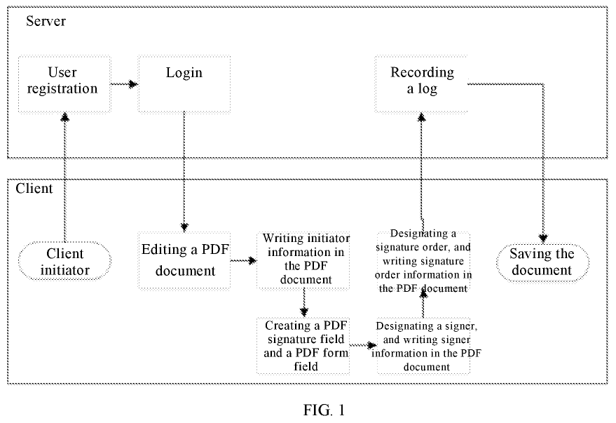

(1) the initiator initiates a signature, see FIG. 1 for this process;

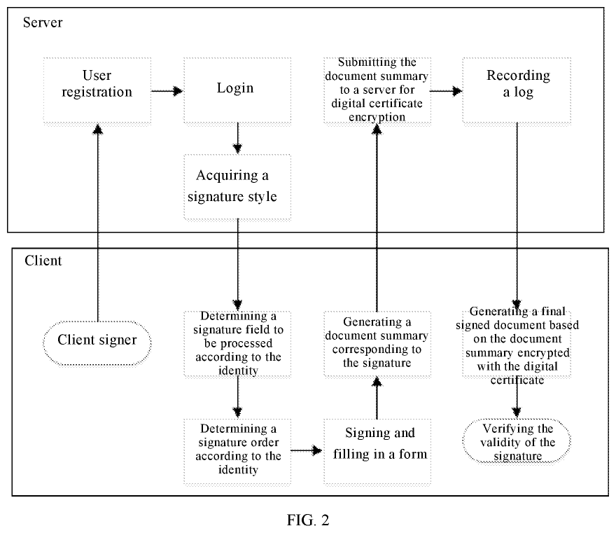

(2) the signer signs the document, see FIG. 2 for this process; and

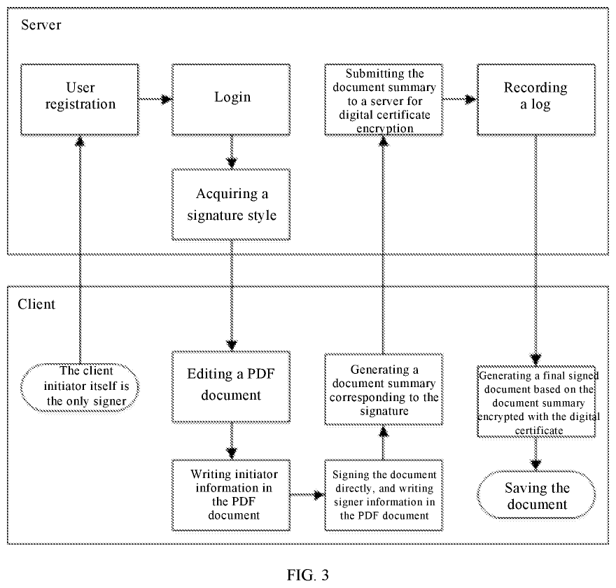

(3) if the initiator itself is the only signer, the document can be signed directly, see FIG. 3 for this process.

In order to implement the functions of the above 3 main processes, the client needs to implement the following main functions, and needs to extend the standard of the PDF form.

(1) User login is performed. The client determines identities of the signature initiator and signer according to the user's login.

(2) A PDF document is read and edited.

(3) a PDF form is created. Form fields of a standard PDF form include: a signature field, a checkbox, a radio button, a combo box, a list box, a text field, and the like. The signature field may be a full signature or an abbreviated signature. These PDF form fields at the designated positions in the PDF document can be created by using a PDF form tool.

(4) The standard PDF form field is extended to support: designating signers; designating an order of signers' signatures; and if the form fields designate a signer, the signer needs to fill in these form fields before signing the signature.

For the PDF form standard, the following extensions need to be made. One entry in the PDF form dictionary (see “Table 8.67 Interactive Form Dictionary Entries” in the PDF standard) needs to be extended:

Extended Entry in Interactive Form Dictionary

| Key | Type | Value |
|---|---|---|
| FoxitSign | Dictionary | (Optional) This dictionary contains information |
| | | about all initiators and signers. |

FoxitSign Dictionary Entries

| Key | Type | Value |
|---|---|---|
| Endpoint | Character | (Required) A service address of a signature |
| | string | service provider. |
| Initiator | Dictionary | (Optional) This dictionary contains initiator |
| | | related information. |
| Signers | Array | (Optional) Each element in this array is |
| | | information about each signer. The type of each |
| | | array element is indirect object. |
| Sort | Boolean | (Optional) This value is true to indicate that the |
| | | signer has a signature order, and an order of |
| | | elements in “Signers” array represents a signer's |
| | | signature order. This value of false indicates that |
| | | the signer has no signature order. A default value |
| | | is false. |

Initiator Dictionary Entry

| Key | Type | Value |
|---|---|---|
| Name | Character | (Optional) a name of the initiator. |
| | string | |
| Email | Character | (Optional) an email address of the initiator. |
| | string | |

Signer Dictionary Entry

| Key | Type | Value |
|---|---|---|
| Type | Name | (Required) The value must be Signer. |
| Name | Character | (Optional) The signer's name. |
| | string | |
| Email | Character | (Optional) The signer's email address. |
| | string | |

In addition, in order to optimize the solution of the present disclosure, one entry in the PDF form field dictionary (see “Table 8.69 Common Entries in All Form Field Dictionaries” in the PDF standard) needs to be extended:

Extended Entry in Interactive Form Dictionary

| Key | Type | Value |
|---|---|---|
| Signer | Dictionary | (Optional) Its value is an element in the |
| | | “Signers” array. |

The value of Signer is one piece of the signer related information, such as Type, Name, Email, etc. recorded in this embodiment, that is, a signer's name, address, type, and the like.

In a specific implementation, an extension example is used to illustrate an extension mode of the form field:

```
  %PDF-1.7
  ......
  14 0 obj
  << /AcroForm 17 0 R /Metadata 2 0 R /Pages 11 0 R /Type /Catalog >>
  Endobj
  17 0 obj
  << /FoxitSign << /Endpoint (https://foxitsign.com) /Initiator << /Name (James)
/Email (james@foxitsoftware.cn) >> /Signers [18 0 R 19 0 R] /Sort true >> /DA
(/SimSun 0 Tf 0 g) /DR << /Font << /Helv 6 0 R /SimSun 7 0 R /ZaDb 8 0 R >> >> /Fields
[20 0 R 21 0 R] >>
  endobj
  18 0 obj
  <</Type /Signer /Name (Peng) /Email (peng_huang@foxitsoftware.cn) >>
  endobj
  19 0 obj
  <</Type /Signer /Name (Kevin) /Email (65908769@qq.com) >>
  endobj
  20 0 obj
  << /P 4 0 R /BS << /S /S /W 1 >> /T (Signature_0) /Rect [173.507996 739.940979
232.113007 773.154968] /F 4 /Subtype /Widget /Type /Annot /DA (/Helv 0 Tf 0 0 0 rg) /M
(D:20200324174853+08‘00’) /MK << >> /FT /Sig /AP << /N 16 0 R >> /NM
(371182dc-cd53-4d59-9529-0f328245dd5c) /Signer 18 0 R>>
  endobj
  21 0 obj
  << /DA (/Helv 12 Tf 0 g) /F 4 /FT /Tx /MK << >> /P 15 0 R /Rect [212.807007
704.284058 362.806976 726.284058] /Subtype /Widget /T (Text2) /Type /Annot /Signer 19
0 R >>
  Endobj
  ......
  xref
  trailer<< /DecodeParms << /Columns 4 /Predictor 12 >> /Filter /FlateDecode /ID
[<E7A82AD0B8A5CBAFD137456AAC1B1AFA>
<BB29E4EF107109438D3FC8213F4CC753>] /Index [13 10] /Info 12 0 R /Length 44 /Prev
5732 /Root 14 0 R /Size 0 /Type /XRef /W [1 2 1] >>
  startxref
  0
  %%EOF
```

The form field expansion mode is described above through a computer language method. As a person skilled in the art, a specific implementation manner recorded in the above example can be understood based on a basic programming language, and will not be described repeatedly with a language.

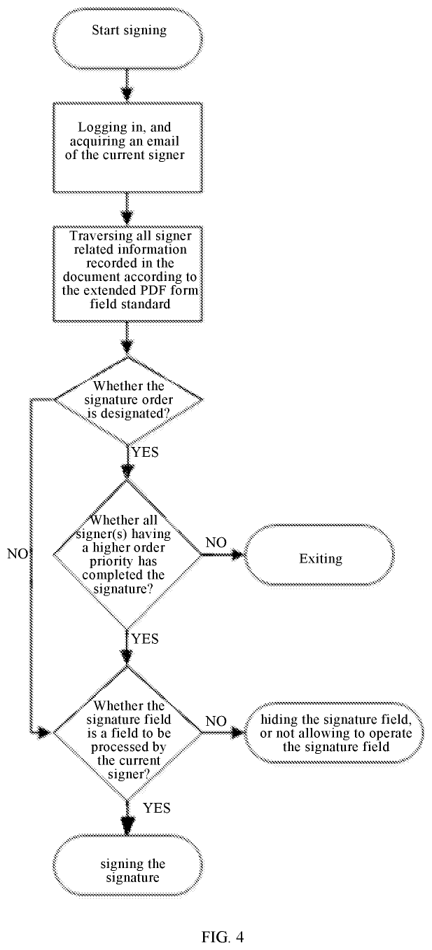

(5) Based on the above extension, during the signature process, a client needs to determine that which signature fields are signed and which form fields are filled in need to be completed by the currently logged-in identity. The client also needs to determine the current signer's signature order. The implementation process of the program is shown in FIG. 4.

(6) A signature style is acquired from the server, and a signature tool is used to sign the signature field. After signing the signature, the client needs to generate a document summary corresponding to the signature, and submit the document summary to the server for digital certificate encryption. The client uses the document summary encrypted with the digital certificate returned by the server to generate a final signed document. After the signed document is signed with the digital certificate, validity of the signature can be verified. If the document has been modified, the signature will be invalid.

It can be seen from the above content that, the signature process of the PDF document can be completely simplified through the extension mode of the present disclosure, and compared with the prior art, is more concise and convenient to set and use.

### Embodiment 2

In yet another embodiment, the present disclosure further provides a system for simplifying an electronic signature process based on a PDF document. The system can execute or implement the electronic signature method as given in Embodiment 1. In the specific implementation, the system can be set as follows to include:

a form extension module configured to create a standard PDF form field, and extend the standard PDF form field;

a client module used by an initiator configured to edit a PDF document in a client, write initiator information in the PDF document, create a PDF signature field and a PDF form field, designate a signer and write signer information in the PDF document, designate a signature order and write signature order information in the PDF document; and configured to:

determine the signature field and the signature order, that needs to be processed by the signer, for the signer to sign and fill in a form, generate a corresponding document summary, generate a final signed document by the client based on the document summary encrypted with a digital certificate, and verify validity of the signature; and

a server module used by the signer and initiator to log in, configured to acquire a signature style; encrypt the digital certificate of the document summary submitted by the signer; and verify the validity of the signature, wherein

the form extension module is arranged in the client module or independently arranged outside the client module. The specific setting mode of the form extension module can be set according to user's needs. For example, the user can set this module separately, independently from the client and the server, to appropriately extend PDF separately, or set this module in the client module, that is, the client contains a module for implementing a form extension function. The form extension module can also be configured in a server module. For example, through a server provider or other channels, this form extension module is integrated into the server, and when the client is in use, the form extension module on the server is called to implement the expansion of a PDF form. All of these setting modes should be regarded as falling within the protection scope of the present disclosure.

Preferably, the server is also used to record a log in the signature process.

Preferably, the form extension module configured to extend the standard PDF form field includes:

adding a FoxitSign dictionary entry in the standard PDF form field, the FoxitSign dictionary entry using a FoxitSign key as a primary key and having a value containing initiator and/or signer related information; and

adding a Signer dictionary entry in the standard PDF form field, the Signer dictionary entry using a Signer key as a primary key and having a value being one piece of signer related information; and the Signer dictionary entry being configured in an interactive form field dictionary.

Preferably, the FoxitSign dictionary entry includes: a character string type entry Endpoint having a value being a service address of a signature service provider; a dictionary type entry Initiator having a value being initiator related information; an array type entry Signers having a value being information related to each signer, where the type of each array element is an indirect object; and a boolean type entry Sort having a value indicating whether there is a signature order.

Preferably, the dictionary type entry Initiator includes: a character string type entry Name having a value being a name of the initiator; and a character string type entry Email having a value being an email address of the initiator.

Preferably, an entry Signer contained in the array type entry Signers includes: a name type entry Type having a value of Signer; a character string type entry Name having a value being a name of the signer; and a character string type entry Email having a value being an email address of the signer.

Preferably, the client determines the signature field and the signature order to be processed according to the login identity of the signer by means of the following steps:

step 31: acquiring an email of the current signer;

step 32: traversing all signer information recorded in the document according to the extended standard PDF form field;

step 33: determining whether the signature order is designated, if YES, proceeding to step 34, and if NO, proceeding to step 35;

step 34: determining whether all signer(s) having an order priority higher than that of the current signer has completed the signature, if YES, proceeding to step 35, and if NO, exiting; and

step 35: determining whether the signature field is a field to be processed by the current signer, if YES, processing and signing the signature, and if NO, hiding the signature field, or not allowing to operate the signature field.

Except for the above aspects, the technical solution of the present disclosure may also be implemented in a device manner. The device may at least include a processor and a memory, wherein the memory stores an executable instruction therein; and the processor can read the executable instruction in the memory to perform the above-mentioned method for simplifying the electronic signature process based on the PDF document. Alternatively, the device may include the system for simplifying the electronic signature process based on the PDF document in Embodiment 2, so as to execute the method for simplifying the electronic signature process based on the PDF document as mentioned in Embodiment 1.

Those of ordinary skill in the art can understand that all or part of the processes in the method of the above embodiment can be implemented by instructing relevant hardware through a computer program which may be stored in a computer-readable storage medium. Upon the execution of this program, the processes of the embodiments of the above-mentioned method may be included. The storage medium may be a magnetic disk, an optical disk, a read-only memory (ROM), a random access memory (RAM) or the like.

It should be eventually noted that: the above embodiments are only used to illustrate the technical solutions of the present disclosure, but not to limit them. Although the present disclosure has been described in detail with reference to the foregoing embodiments, it should be understood by those of ordinary skill in the art that: the technical solutions described in the foregoing embodiments can be still modified, or equivalent replacements to some of the technical features are performed. However, these modifications or substitutions do not make the essence of the corresponding technical solutions deviate from the spirit and scope of the technical solutions of the embodiments of the present disclosure.

1. A method for simplifying an electronic signature process based on a PDF document, comprising:
step 1: creating a standard PDF form field, and extending the standard PDF form field; proceeding to step 4 when a signer is an initiator, and proceeding to step 2 when the signer is not an initiator;
step 2: logging in to a server by the initiator; and then editing a PDF document in a client, writing initiator information in the PDF document, creating a PDF signature field and a form field, designating the signer, and writing signer information into the PDF document; designating a signature order, and writing signature order information in the PDF document; transmitting the signature order information to the server, and saving the PDF document in the client;
step 3: logging in to the server by the signer, and acquiring a signature style from the server, and determining, by the client, a signature field and a signature order to be processed according to a login identity of the signer; signing, by the signer, a signature, and generating a corresponding document summary; submitting, by the client, the document summary to the server for digital certificate encryption; generating, by the client, a final signed document based on the document summary encrypted with the digital certificate, and verifying validity of the signature; and
step 4: logging in to the server by the initiator, and then acquiring a signature style; editing the PDF document in the client, and writing the initiator information in the PDF document; signing the signature in the PDF document, and writing signer information into the PDF document; generating a document summary corresponding to the signature; submitting, by the client, the document summary to the server for digital certificate encryption; and generating, by the client, a final signed document based on the document summary encrypted with the digital certificate.

2. The method according to claim 1, wherein in the step 1, extending the standard PDF form field comprises:
adding a FoxitSign dictionary entry in the standard PDF form field, the FoxitSign dictionary entry using a FoxitSign key as a primary key and having a value containing initiator and/or signer related information; and
adding a Signer dictionary entry in the standard PDF form field, the Signer dictionary entry using a Signer key as a primary key and having a value being one piece of signer related information; and the Signer dictionary entry being configured in an interactive form field dictionary.

3. The method according to claim 2, wherein the FoxitSign dictionary entry comprises: a character string type entry Endpoint having a value being a service address of a signature service provider; a dictionary type entry Initiator having a value being initiator related information; an array type entry Signers having a value being information related to each signer, where the type of each array element is an indirect object; and a boolean type entry Sort having a value indicating whether there is a signature order.

4. The method according to claim 3, wherein the dictionary type entry Initiator comprises: a character string type entry Name having a value being a name of the initiator; and a character string type entry Email having a value being an email address of the initiator.

5. The method according to claim 3, wherein the entry Signer contained in the array type entry Signers comprises: a name type entry Type having a value of Signer; a character string type entry Name having a value being a name of the signer; and a character string type entry Email having a value being an email address of the signer.

6. The method according to claim 1, wherein in the step 3, the client determines the signature field and the signature order to be processed according to the login identity of the signer by means of the following steps:
step 31: acquiring an email of the current signer;
step 32: traversing all signer information recorded in the document according to the extended standard PDF form field;
step 33: determining whether the signature order is designated, if YES, proceeding to step 34, and if NO, proceeding to step 35;
step 34: determining whether all signer(s) having an order priority higher than that of the current signer has completed the signature, if YES, proceeding to step 35, and if NO, exiting; and
step 35: determining whether the signature field is a field to be processed by the current signer, if YES, processing and signing the signature, and if NO, hiding the signature field, or not allowing to operate the signature field.

7. The method according to claim 1, wherein the server is further used to record a log in the signature process.

8. A system for simplifying an electronic signature process based on a PDF document, comprising:
a form extension module configured to create a standard PDF form field, and extend the standard PDF form field;
a client module used by an initiator configured to edit a PDF document in a client, write initiator information in the PDF document, create a PDF signature field and a PDF form field, designate a signer and write signer information in the PDF document, designate a signature order and write signature order information in the PDF document; and configured to:
determine the signature field and the signature order, that needs to be processed by the signer, for the signer to sign and fill in a form, generate a corresponding document summary, generate a final signed document by using the client based on the document summary encrypted with a digital certificate, and verify validity of the signature; and
a server module used by the signer and initiator to log in, configured to acquire a signature style; encrypt the digital certificate of the document summary submitted by the signer; and verify the validity of the signature, wherein
the form extension module is arranged in the client module or independently arranged outside the client module.

9. The system according to claim 8, wherein the form extension module configured to extend the standard PDF form field comprises:
adding a FoxitSign dictionary entry in the standard PDF form field, the FoxitSign dictionary entry using a FoxitSign key as a primary key and having a value containing initiator and/or signer related information; and
adding a Signer dictionary entry in the standard PDF form field, the Signer dictionary entry using a Signer key as a primary key and having a value being one piece of signer related information; and the Signer dictionary entry being configured in an interactive form field dictionary.

10. A device for simplifying an electronic signature process based on a PDF document, at least comprising a processor and a memory, wherein the memory stores an executable instruction therein; and the processor can read the executable instruction in the memory to perform the method for simplifying the electronic signature process based on the PDF document according claim 1.
